(19) United States
(12) Patent Application Publication
(10) Pub. No.: US 2004/0245216 A1
(43) Pub. Date: Dec. 9, 2004

(54) Devices and method of their manufacture

(76) Inventors: Chien-Shing Pai, Bridgewater, NJ (US); Stanley Pau, Hoboken, NJ (US); Joseph Ashley Taylor, Orlando, FL (US)

Correspondence Address: Mr. Bruce S. Schneider, 1153 Long Hill Road, Stirling, NJ, 07980-1007, US

(21) Appl. No.: 10/456,659

(22) Filed: Jun. 6, 2003

(51) Int. Cl. B44C 1/22

(52) U.S. Cl. 216/58

(57) ABSTRACT

In fabricating an apparatus such as a silicon device or an optical device initially a wafer having a plurality of dies is formed. These dies are then separated into individual dies and the individual dies are formed into encapsulated devices having input and/or output leads. The dies are separated by a means that is not based on crystallographic plane cleavage. Additionally the boundary along which the separation is performed is not a linear path. By employing non-linear paths that are not constrained by crystallographic planes, device yield per wafer is substantially improved particularly for dies having non-linear boundaries. In one embodiment the dies are separated using an alternating dry etching and polymer deposition technique.

### FIELD OF THE INVENTION

This invention relates to the manufacture of devices such as optical or semiconductor devices and in particular to the manufacture of such devices using a wafer having a plurality of dies.

### BACKGROUND OF THE INVENTION

In the manufacture of many devices such as optical devices, e.g., arrayed waveguides, semiconductor devices, e.g., integrated circuits, and MEMS (Micro-Electro-Mechanical Systems as discussed, for example in Bright, V. M., Ed. (1999). “Selected Papers on Optical MEMS,” SPIE Milestone Series 153, in Micromechanics and MEMS, ed. by Trimmer, W. S.), a plurality of precursors to such devices are formed on a substrate that is relatively large compared to an individual precursor. For example, in the formation of integrated circuits on a silicon wafer, the wafer substrate is 4, 6, 8, 10, to as large as 12 inches in diameter. In comparison, a large precursor for an integrated silicon circuit has dimensions on the order of 10 mm by 10 cm. Thus in the example of silicon integrated circuits even for larger precursors up to 400 precursors are fabricated on a single wafer.

The precursor is formed having device structures. Such device structures are identifiable formations such as a source, drain, or gate in an integrated circuit, a grating in an array waveguide (AWG), a mirror in a MEMS device or a reaction chamber in a microchemical reactor. Further, the device structure interacts with an input entity (light, current, voltage, or fluid mass flux) and in combination with other structures, or alone, changes in such input entity a characteristic such as its phase, amplitude, direction, displacement or a chemical property. The size of such structures varies from as small as 80 μm in a silicon integrated circuit to often as large as 1 mm to 1 cm, or even as large as 10 cm, and in some instances as large as 120 mm in a MEMS device. The precursor with its structures is formed on the wafer using processes such as etching, metallization, ion implantation, and deposition. (See Madou, M. (1997). Fundamentals of Microfabrication, CRC Press for a general description of such fabrication processes.)

These precursors are typically called dies in the art. In the fabrication of the device from the precursors the wafer is cut so that the dies are physically separated one from another. Dies then are generally tested and further processed, if viable, to have input and/or output leads for connection to other devices external to the device being formed. The die with its leads is typically encapsulated for example in a polymer material (see Chang, C. Y. and Sze, S. M. (1996). ULSI Technology, McGraw-Hill, pages 555 to 556.) The resulting die with its leads and its encapsulation protection is employed in a variety of applications such as MEMS, integrated circuits, microchemical reactors (see Senturia, S. D. (2001) Microsystem Design, Kluwer Academic, page 605) waveguides and other electrical, optical, chemical and/or mechanical devices. (Typical procedures for forming external leads and for encapsulation can be found in Madou, supra.)

There are two primary approaches for the physical separation of dies in a wafer. In dies for devices such as integrated circuits formed on single crystal wafers, the wafer is in one approach, cleaved along a crystallographic plane causing a separation of the wafer into two entities. (For the purpose of this invention crystallographic planes are defined as thermodynamically preferred cleavage planes under the conditions and for the crystal involved as described in Phillips, F. C. (1979). An Introduction to Crystallography, John Wiley & Sons, Chapter 3, “Crystal Geometry.”) To accomplish a cleave along a crystallographic plane generally the wafer is scored in the appropriate crystallographic direction for the cleave. After scoring, pressure on either side of the score is introduced such as with a Diamond Touch DS Scribing Tool in conjunction with DIAFrame™ Wafer Carrier to induce a complete physical separation along the score from one point on the perimeter of the wafer to a second point on the perimeter. Scoring or scribing (as this term is used in the art) has been accomplished for example with a diamond scriber is used to produce a scratch typically several tens to one or two hundreds of micrometers in depth along a distance generally in the range 1 mm to a substantial portion of the major surface of the wafer.

In a second approach to the separation of dies, an abrasive disc is employed to cut through the entire thickness of a wafer from one point on the perimeter on the wafer to a second point on the perimeter. This process as exemplified in U.S. Pat. No. 6,281,031 dated Aug. 28, 2001 is analogous to the cutting of wood using a table saw. In contrast, however, the kerf of the abrasive disc is typically between 50 and 200 μm.

When either cleaving or abrasive cutting is used for separation, the boundary formed along the separated entities is linear. In the case of crystallographic cleavage clearly the crystallographic plane is linear and therefore the exposed boundary has a corresponding linear geometry. Similarly the use of an abrasive disc by the very nature of the disc geometry correspondingly produces a linear separation.

A linear boundary of separation is characterized by the contour of the pathway defining the separation between two portions of a wafer upon dicing. The linearity of such pathway is considered with respect to three points along the pathway with a distance along the pathway between the outermost two (denominated the endpoints) of the three points being at least 5% of the major dimension of the dies being separated. (To determine such major dimension, a characteristic dimension is ascertained for each die in the two portions of the wafer being separated. This characteristic dimension is the largest side of the smallest rectangle in which the die can be inscribed. The smallest of these characteristic dimensions is the major dimension.) The portion of the separation pathway between any two endpoints is linear if for all choices of a point (denominated an intermediate point) between endpoints having the requisite separation distance, there exists no intermediate point that deviates transversely more than 1% of the major distance from an imaginary line connecting the endpoints.

Although both separation by cleaving and by sawing have proven to be fundamentally sound, improvement in the device fabrication process is always desirable.

### SUMMARY OF THE INVENTION

In the fabrication of many devices it is advantageous that at least a portion of the separation pathway be non-linear. That is, for the three points as defined supra to characterize a linear separation pathway a complimentary criterion is satisfied. In particular, the pathway between two endpoints having requisite separation of 5% of the major dimension is nonlinear if there exists an intermediate point that deviates transversely more than 1% of the major dimension from an imaginary line connecting the two endpoints. (The endpoints should not be chosen on either side of the point that defines the intersection of two linear regions. Thus a pair of points with one on either side of such intersection point are not endpoints in the context of this invention.) In exemplary embodiments the deviation is more than 2% and even more than 3%.

For such devices if linear techniques for die separation are employed a substantial area of the wafer is wasted. As shown in FIG. 1 without the inventive technique for curved device structures in dies, 1, and 2 the space, 5, between the edge 6 of the device structures, 3, and the linear separation boundary 7 between dies, 1 and 2, is wasted. Clearly the greater the deviation of the die from linear boundaries the more extensive the extent of this waste. Therefore a process where a portion of the separation boundary is non-linear allows more non-linear dies to be formed on the wafer and successfully separated thereby allowing more efficient die packing on wafers. (Successful separation is the physical separation of two dies such that the device ultimately formed from the die functions to produce a useful effect.) Since a non-linear boundary is desired, to accomplish this goal, neither crystallographic cleavage nor the use of an abrasive disc is employed to produce the non-linear boundary.

In one embodiment of the invention the non-linear separation boundary i.e. a boundary of separation having a non-linear portion is formed using a lithographic etch mask and a deep dry etch technique such as that described in the context of producing device structures by U.S. Pat. No. 5,501,893 dated Mar. 26, 1996 which is hereby incorporated by reference in its entirety. In the subject invention this process is adapted so that instead of, or in addition to, forming device structures, a separation through the entire thickness of the wafer from one part on the wafer perimeter to another is employed to produce a separation of an entity from the wafer. That is, in the separation of two portions of the wafer from one another, two resulting portions are yielded each containing at least one die. By configuring the etch mask by standard techniques such as described in Thompson et. al. (1994). Introduction to Microlithography, ACS Professional Reference Book, an enormous flexibility in the non-linear geometry of the separation boundary is achievable.

In the embodiment employing etching greater freedom in the contour of the separation boundary, i.e. the etch pit, is available. In particular for any continuous etch pit forming a separation boundary or a portion of the separation boundary, advantage is gained, as discussed, by forming such etch pit to have other than a linear configuration. Thus etch pits are useful that are, for example, circular in contour, zigzag in contour formed from straight line segments, or approximations to curves formed by straight line segments of the etch pit that are chords of such curve.

By using the inventive technique the yield of a wide variety of devices such as arrayed waveguide gratings, MEMS, integrated circuits, and microchemical reactors, is enhancable while the territory required for such separation, e.g., typically 100 μm to 1 mm or larger, is substantially reduced relative to conventional techniques. Thus, there is an even further opportunity to increase the number of dies on a wafer that it is possible to successfully separate. Since dry etching techniques are employable, there is, in contrast to abrasive separation techniques, essentially no debris left on the surface of the wafer. Debris often causes loss of yield, and thus debris reduction is advantageous. The devices ultimately formed by adding external leads and encapsulating are obtained in correspondingly increased yield. Additionally since the techniques employed for separation, e.g., lithography and dry etching are conventional, new techniques need not be introduced into the device fabrication process.

### BRIEF DESCRIPTION OF THE DRAWINGS

FIG. 1 is exemplary of inefficiencies in conventional die separation;

FIG. 2 demonstrates a suitable process for die separation;

FIG. 3 and FIG. 4 illustrate a concept involved with non-linear separation boundary.

### DETAILED DESCRIPTION OF THE INVENTION

As discussed the invention involves the manufacture of dies having at least a portion of its perimeter non-linear for ultimate formation into devices. Indeed, in one such embodiment such a portion comprises a smooth non-linear curve. For embodiments in which etching is used, the contour of the etch is less constrained and etching contours that are other than linear are employable. In this context an other than linear contour occurs where it is possible to choose endpoints corresponding to two points on a continuous etch pit (ultimately forming a separation boundary) that does not define a linear segment. Specifically there exists for some pair of endpoints an intermediate point along the etch pit contour between the endpoints that deviates transversely more than 1% of the major distance from an imaginary line connecting the endpoints.

In accordance with the invention a wafer is physically separated into portions denominated separated entities that each contain at least one die. (As discussed earlier a die is a portion of a wafer containing device structures such that when the die is formed into a device by processes including providing external leads, the device produces useful results on an input optical, electrical, or other entity.) Exemplary materials employed in a wafer include single crystal silicon, polycrystalline silicon, single crystal or polycrystalline compound semiconductor materials such as III-IV semiconductor materials. Although presently etching rates for some materials are slow, the invention is still applicable.

Substrates of various crystalline nature are useful. Thus single crystalline wafers, i.e., wafers having crystal defect densities other than dopant defects less than 10¹² per cm³ are employable. Similarly, polycrystalline and amorphous materials forming the substrate are also acceptable. The shape of the wafer is not significant. However, typically wafers have essentially round shapes with notches for alignment or identification purposes. Additionally the dimensions of the wafer are also not critical to the invention. Generally for integrated circuits, wafers of 2 inches, 4 inches, 6 inches, 8 inches, and even 12 inches in diameter are presently employed for various devices. Similarly in the manufacture of MEMS devices, wafers having dimensions 1 mm to 10 cm are often employed while for optical devices such as AWGs dimensions of 5 cm to 20 cm are typically encountered. The thickness of the wafer also varies depending on the device being manufactured. Optical devices, integrated circuits, and MEMS dies generally are formed on wafers having thicknesses in the range 200 μm to 1 mm for integrated circuits, and 300 μm to 800 μm for AWGs and MEMS.

In one embodiment physical separation of the dies in a wafer is accomplished using lithography in combination with dry etching. The particular lithographic mask employed for a particular die depends on the thickness of the wafer and the selectivity between the wafer material and the mask material of the etch process. Generally for conventional resist materials such as Shipley 5740 (a polymer based resist), thicknesses up to 15 μm are employable. Other resist materials are employable in thicknesses up to 100 μm such as Shipley SU8. For such resist mask thicknesses up to 15 μm, etches as deep as 600 μm are possible. For greater thickness etch depth reaching the full thickness of even a 12 inch wafer is possible. The particular radiation and parameters employed for such exposures are conventional and are discussed in a variety of texts such as Thompson, supra. Other mask materials such as AIN are useful for deeper etches in, for example, silicon. The deposition of such material is typically in the thickness range 100 to 300 nm and it is formed into a mask by conventional techniques. For wafers thicker than 600 μm or if the etch pit aspect ratio exceeds 30:1, physical separation is aided by etching from both sides of the wafer. In particular etching to a depth up to 600 μm is performed on one side of the wafer. Then after formation of a corresponding mask aligned with the original etching pattern on the first wafer face, etching is performed on the opposing wafer face. The required alignment of masks on the two faces is conventional and is generally performed by infrared or backside alignment such as is accomplished with tools such as Karl Suss MA8 contact printer manufactured by SUSS Microtec Inc., Vermont, USA allowing alignment as accurate as 2 μm or better.

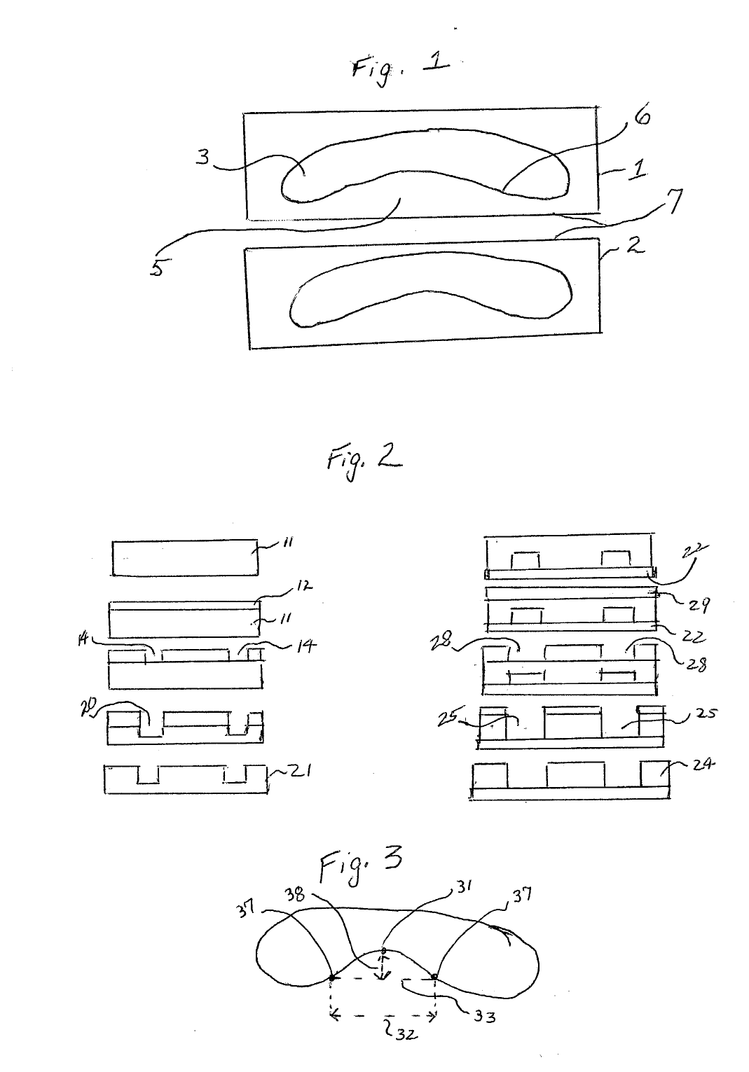

Thus in one embodiment the wafer, 11, in FIG. 2 is coated with a resist 12 that is exposed in the desired pattern and developed to have openings as shown at 14 where die separation is contemplated. The resulting pattern is then employed for separation through, for example, dry etching. One useful technique for dry etching is described in U.S. Pat. No. 5,501,893 which is incorporated herein by reference in its entirety. Although it is possible to practice this process with a variety of different etching equipment one suitable etcher is described in the production specifications for Alcatel 601 E Deep Etching System dated July 1998. This Alcatel etcher is an automated plasma etching system designed for deep silicon etching such as in the fabrication of MEMS devices. This equipment has a high density plasma source with a single wafer process chamber. The source operates at 13.56 MHz using an automatic RF matching network with inductive coupling of the wafer. The plasma is magnetically stabilized and the chamber walls are water cooled. The plasma is confined so that it does not enter the wafer transfer chamber.

A Surface Technology Systems Inc. of California USA (ICP) etcher is also employable. (This etcher and an associated deep etching process is described in McAuley, et. al. (2001). Journal of Physics D: Applied Physics, 34, 2769, which is hereby incorporated by reference in its entirety.) The wafer is exposed to a plasma containing suitable etching entities for the material of the wafer. For example in the case of a silicon wafer a mixture of SF₆ and oxygen gas is introduced into the plasma to produce an etching species. Mole ratios of SF₆ to O₂ are generally in the range 10 to 60. Similarly for materials such as GaAs, quartz and glasses, and alumina corresponding gases of chlorine containing gases such as Cl₂, HCl, and BCl₃, fluorine containing gases such as C₂F₆, and chlorine containing gases such as Cl₂ are useful. Generally, the power introduced into the plasma for silicon etching should be in the range 300 watts to 3000 watts. While power greater than 3000 watts is possible, it is not easily achieved. Power less than 300 watts yields disadvantageously slow etch rates. Typically the source of the plasma power is a 13.56 MHz microwave source. For etching involving chlorine entities powers in the range 300 to 1000 watts are useful while for fluorine entities for glass etching 300 to 3000 watts are employable.

The gas flow rates that provide the etching species are in the range 10 sccm to 100 sccm. Flow rates greater than 100 sccm often lead to excessive resident times while flow rates lower than 10 sccm often yield undesirably low etch rates. However, these values change somewhat for differing vacuum pump rates and desired partial pressures. A control sample is easily employable for a specific etching tool to refine such parameters for the specific conditions employed.

It is desirable to produce a power bias between the plasma and the substrate holder for high density etchers in the range 10 to 300 watts. Power biases less than 10 watts produce excessive loss of anisotropy while biases greater than 100 watts induce wafer damage.

To enhance anisotropy after etching has proceeded through a thickness of 0.5 to 1 μm the etching is terminated and a sidewall deposition process is instituted. Typically the power and flow rates are similar to that used for the etching step. Powers in the range of 300 to 1200 watts and flow rates in the range 50 to 200 sccm are suitable for example for silicon. The gas introduced is changed from the etchant to a sidewall deposition former such as C₄F₈, CHF₃, or other fluorocarbon gases. The deposition process is continued to produce sufficient thickness of deposited material to protect the sidewalls through the next etch interval. Deposition times in the range 5 to 10 seconds are generally sufficient. The process of etching and deposition is alternated until physical separation of dies is accomplished or if two sided etching is to be employed until wafer face reversal is performed. Such alternating process produces a scalloped edge normal to the major surface of the wafer.

In the circumstance that etching is performed from both major faces of the wafer the alternating etch and sidewall deposition process is used first on one side of the wafer, typically to depth half the wafer thickness e.g. in the range 200 to 500 μm as shown in FIG. 2 at 20. The resist is stripped as shown at 21. The etched side of the wafer is then coated (22 in FIG. 2) to hold the separated pieces together so that they can be removed from the etching chamber. Generally a thickness in the range 0.5 to 2 μm for deposited oxide and up to 15 μm for a resist is adequate to hold the pieces during transfer. Alternatively, a dicing tape is employable. As discussed layer 22 is coated on the etched side and the wafer major faces are exchanged in the etcher. A mask 29 is produced on a new exposed major surface of the wafer and patterned to yield mask openings 28. Alternating etching and deposition steps are then continued until the etch pit traverses the wafer as shown at 25. The resist mask is removed as shown at 24 utilizing commercial resist stripping solvent or an oxygen plasma. If the mask is AIN, then a solution containing ⁻OH entities is employed for removal. After the wafer is taken from the etching apparatus the material holding the separated pieces together is removed using in the case of resist, commercial stripper or in the case of an oxide, HF solution taking precautions to avoid damage to susceptible precursor structures.

The resulting separated dies are employable to produce devices. Addition of input and/or output leads and encapsulation of the die are conventional and are described in Kosnowski, S. G. and Helland, A. R. (1997). Electronic Packaging of High Speed Circuits, McGraw-Hill. Although the addition of leads and encapsulation is conventional, the shape of the resulting die is not.

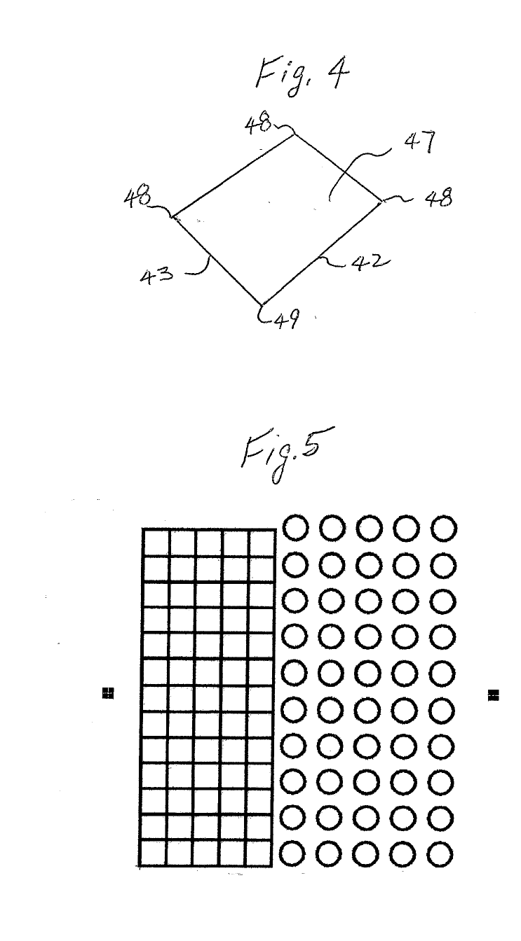

In particular as shown in FIG. 3 in one embodiment at least a portion of the boundary defining the perimeter of the die is nonlinear over a distance along the boundary of at least 5% of the characteristic dimension (as previously defined) of the die. The boundary is considered nonlinear when there exists a midpoint 31 between at least one set of endpoints 37 such that the midpoint deviates transversely more than 1% of the characteristic dimension from an imaginary line 33 connecting the endpoints. The transverse distance 38 is measured in the direction from the midpoint perpendicular to the imaginary line 33 connecting the endpoints of the requisite distance. Portions of the die perimeter following crystallographic planes are not considered in determining if a die has a nonlinear perimeter. Additionally for this determination of nonlinearity, the endpoints should not be chosen on either side of the point that defines the intersection of two linear regions of the perimeter. Thus, as shown in FIG. 4, the endpoints should not be chosen on either side of the intersection 48 of two linear portions on the perimeter of die 47. Similarly, the linear portions defining the intersection 49 along two crystallographic planes 42 and 43 also would not be considered in determining if the die has a nonlinear perimeter.

### EXAMPLE

To demonstrate the etching technique suitable for and in the context of the invention, a silicon wafer measuring 8 inches in diameter, and having a thickness of 725 μm was employed. Five to ten ml of Shipley SJR 5741 was placed in the center of the wafer and the wafer spun at 1200 rpm for 30 seconds to produce a resist layer of 15 μm. A pre-exposure bake was performed at 120 degrees C. for 15 minutes. The wafer was then placed on the stage of a Karl Suss MA8 contact printer and aligner. A mask having a squares and circles pattern as shown in FIG. 5 was inserted in the printer. The resist was exposed for 30 seconds and then developed by immersing in Shipley 455 developer for 5 minutes. The resist mask was hardened by baking at 120 degrees C. for 20 minutes.

The wafer was transferred to the wafer holding stage of an STS Surface Technology System High Rate Advanced Silicon etching system. The system was evacuated to 1.0×10⁻⁷ Torr. (1.33×10⁻⁵ Pa.) An SF₆ flow rate of 125 sccm and an O₂ flow rate of 5 sccm was established and a plasma was struck in the gas mixture using 600 watts for the source power, and 14 watts for the bias power generated by separate 13.56 MHz sources. Etching was continued for 12 seconds. The SF6/O₂ mixture was terminated and C₄F₈ gas was introduced at a flow rate of 95 sccm. The plasma was re-struck using a 600 watt source power and no bias power. This deposition step was continued for 7 seconds. The alternating etch/deposition procedure was continued until the etch depth reached 350 μm. The etch chamber was then evacuated and the wafer removed.

The resist was stripped by immersion in EKC 265 (a product of EKC Technology) resist stripper at 85 degrees C. for 1 hour. The surface having the etched voids was then coated with a layer of 2 μm oxide. This coating was formed by plasma enhanced chemical vapor deposition using silane gas by conventional technique in an Applied Materials Corporation 5000 PECVD tool.

The major surface of the wafer opposite the coated side was then coated with 15 μm of Shipley SJR 5741 resist as previously described. The resist was then pre-exposure baked at 120 degrees C. for 15 minutes. The wafer was inserted on the holder of the Karl Suss MA8 contact printer and aligner. The wafer was aligned and exposed in the same pattern as employed for its opposing side so that the previously etched pattern and the voids in the newly exposed resist aligned. The wafer was then again inserted into the STS etcher and the alternating cycle of etching and deposition as previously described was employed to etch through the wafer. The wafer was then removed from the etcher and the remaining resist stripped by immersion in EKC 265 resist stripper at a temperature of 85 degrees C. for 1 hour. The oxide was removed by dipping in HF solution for approximately 20 minutes and the resist with conventional solvent.

We claim:

1. A process for making an apparatus said process comprising the steps of obtaining a wafer having a plurality of dies physically interconnected as part of said wafer, physically separating at least one of said dies from at least another of said dies by partitioning said wafer along a pathway into a plurality of separated entities, said separated entities comprising at least one of said dies characterized in that 1) said separated entities include a device structure, 2) said partitioning being accomplished by a technique other than crystallographic cleaving, and 3) at least a portion of said pathway is non-linear.

2. The process of claim 1 wherein said separating comprises etching.

3. The process of claim 2 wherein said etching comprises dry etching.

4. The process of claim 3 wherein said etching is performed in an alternating sequence with a deposit step.

5. The process of claim 1 wherein said dies comprise structures adapted for affecting light.

6. The process of claim 1 wherein said dies comprise structures adapted for affecting electrical signals.

7. The process of claim 1 wherein said wafer comprises single crystalline semiconductor material.

8. The process of claim 7 wherein said semiconductor material comprises silicon.

9. The process of claim 1 wherein said wafer comprises a polycrystalline material.

10. The process of claim 1 wherein said non-linear portion of said pathway comprises a smooth curve.

11. The process of claim 1 wherein said separated entities are held together by an oxide, photoresist, or tape.

12. A process for making an apparatus comprising obtaining a wafer having a plurality of dies physically interconnected as part of said wafer, physically separating at least one of said dies from at least another of said dies by partitioning said wafer along a pathway into a plurality of separated entities comprising at least one of said dies characterized in that 1) said separated entity includes a device structure, 2) said partitioning being accomplished by a technique other than crystallographic cleaving, and 3) a portion of said pathway is non-linear over a distance along said pathway of at least 5% of the major dimension of said dies such that the midpoint of said distance along said pathway deviates transversely more than 1% of said major dimension from an imaginary line connecting the end points of said distance along said pathway.

13. A device comprising an encapsulated die having input and output structures, said die having a boundary such that at least a portion of said boundary is non-linear over a distance along said boundary of at least 5% of the characteristic dimension of said die, such that the midpoint of said distance along said boundary deviates transversely more than 1% of the characteristic dimension of said die from an imaginary line connecting the endpoints of said distance along said boundary.

14. The device of claim 13 wherein said die comprises silicon.

15. The device of claim 14 wherein said silicon comprises single crystalline silicon.

16. The device of claim 13 wherein said boundary of said die comprises a scalloped area along the face normal to the major face of said die.

17. A process for making an apparatus comprising obtaining a wafer having a plurality of dies physically interconnected as part of said wafer, physically separating at least one of said dies from at least another of said dies by partitioning said wafer along a pathway into a plurality of separated entities comprising at least one of said dies characterized in that 1) said separated entity includes a device structure, 2) said partitioning is accomplished by etching the wafer to form an etch pit, and 3) the contour along the major face of said wafer of at least a portion of said etch pit is other than linear.

18. The process of claim 17 wherein said etching is accomplished by alternating steps of etching and deposition.
